(19) United States
(12) Patent Application Publication
(10) Pub. No.: US 2026/0101316 A1
(43) Pub. Date: Apr. 9, 2026

(54) METHOD AND APPARATUS FOR TRANSMITTING AND RECEIVING SIGNAL IN COMMUNICATION SYSTEM

(71) Applicant: ELECTRONICS AND TELECOMMUNICATIONS RESEARCH INSTITUTE, Daejeon (KR)

(72) Inventors: Jung Sun UM, Daejeon (KR); Sung Ik PARK, Daejeon (KR); Jae Hyun SEO, Daejeon (KR)

(73) Assignee: ELECTRONICS AND TELECOMMUNICATIONS RESEARCH INSTITUTE, Daejeon (KR)

(21) Appl. No.: 19/346,090

(22) Filed: Sep. 30, 2025

(30) Foreign Application Priority Data
Oct. 4, 2024 (KR) 10-2024-0135183
Feb. 4, 2025 (KR) 10-2025-0013772
Mar. 21, 2025 (KR) 10-2025-0036745
May 9, 2025 (KR) 10-2025-0060210
Sep. 26, 2025 (KR) 10-2025-0139938

(51) Int. Cl. H04W 68/02; H04W 72/044

(52) U.S. Cl. CPC H04W 68/02; H04W 72/044

(57) ABSTRACT

A method of a first communication node may comprise: transmitting, to a second communication node, a paging message including information on a total number of trigger messages; periodically transmitting, to the second communication node, a trigger message including Msg1 occasion configuration information; and receiving, from the second communication node, Msg1 including an identifier of the second communication node in response to the trigger message.

### CROSS-REFERENCE TO RELATED APPLICATIONS

This application claims priority to Korean Patent Applications No. 10-2024-0135183, filed on Oct. 4, 2024, No. 10-2025-0013772, filed on Feb. 4, 2025, No. 10-2025-0036745, filed on Mar. 21, 2025, No. 10-2025-0060210, filed on May 9, 2025, and No. 10-2025-0139938, filed on Sep. 26, 2025, with the Korean Intellectual Property Office (KIPO), the entire contents of which are hereby incorporated by reference.

### BACKGROUND

### 1. Technical Field

The present disclosure relates to a signal transmission and reception technique in a communication system, and more particularly, to a signal transmission and reception technique in a communication system, which enables data transmission and reception considering an energy harvesting state of a wireless device.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Among information and communication technologies, the Internet of Things (IOT) has recently received much attention because it can improve industrial production efficiency and increase comfort in daily life. In IoT, devices can operate without batteries. An IoT device can harvest a necessary energy from wireless signals received from nearby wireless devices and can transmit signals by backscattering the received signals. To this end, the IoT device and the wireless device supplying signals to the IoT device may need to perform signal transmission and reception procedures with each other.

### SUMMARY

The present disclosure for resolving the above-described problems is directed to providing signal transmission and reception methods and apparatuses in a communication system, which enable data transmission and reception considering an energy harvesting state of a wireless device.

According to a first exemplary embodiment of the present disclosure, a method of a first communication node may comprise: transmitting, to a second communication node, a paging message including information on a total number of trigger messages; periodically transmitting, to the second communication node, a trigger message including Msg1 occasion configuration information; and receiving, from the second communication node, Msg1 including an identifier of the second communication node in response to the trigger message.

The paging message may further include information for initiating an inventory procedure.

The trigger message may further include at least one of: information on a current transmission round, information on a time interval until a next trigger message, or information on a number of remaining trigger messages.

The Msg1 occasion configuration information may include at least one of: information on a frequency of a carrier wave, information on a small frequency shift value, information on slots corresponding to a slotted Aloha transmission procedure, information on a time-domain transmission resource, or information on a frequency-domain transmission resource.

The information on slots corresponding to the slotted Aloha transmission procedure may include at least one of: information on a total number of slots, information on a start time of a first slot, information on a time length of a slot, information on a start time at which the slots are configured, or information on an end time at which the slots are configured.

The information on the time-domain transmission resource may include at least one of: information on a number of transmission resources, information on a start time of the transmission resource, information on a first time offset between the transmission resource and an adjacent transmission resource, information on a second time offset indicating a start time of the transmission resource, information on a minimum transmission time of the transmission resource, or information on a maximum transmission time of the transmission resource.

The method may further comprise: transmitting, to the second communication node, Msg2 including the identifier of the second communication node or Msg3 occasion configuration information; and receiving Msg3 from the second communication node.

The Msg1 may include information on an energy state change of the second communication node, and the transmitting of the Msg2 may comprise: adjusting a transmission time of Msg2 by taking into account the energy state change; and transmitting Msg2 to the second communication node at the adjusted transmission time.

According to a second exemplary embodiment of the present disclosure, a method of a second communication node may comprise: receiving, from a first communication node, a paging message including information on a total number of trigger messages; periodically receiving, from the first communication node, a trigger message including Msg1 occasion configuration information; and transmitting, to the first communication node, Msg1 including an identifier of the second communication node in response to the trigger message.

The trigger message may further include at least one of: information on a current transmission round, information on a time interval until a next trigger message, or information on a number of remaining trigger messages.

The Msg1 occasion configuration information may include at least one of: information on a frequency of a carrier wave, information on a small frequency shift value, information on slots corresponding to a slotted Aloha transmission procedure, information on a time-domain transmission resource, or information on a frequency-domain transmission resource.

The method may further comprise: receiving, from the first communication node, Msg2 including the identifier of the second communication node or Msg3 occasion configuration information; and transmitting, to the first communication node, Msg3 in response to the Msg2.

The Msg1 may include information on an energy state change of the second communication node, and the receiving of the Msg2 may comprise: configuring a monitoring time of the Msg2 according to the energy state change; monitoring the Msg2 at the configured monitoring time; and receiving the Msg2 at the configured monitoring time.

The method may further comprise: determining a duration for maintaining a sleep mode based on a number of trigger messages; and maintaining the sleep mode for the determined duration.

According to a third exemplary embodiment of the present disclosure, a second communication node may comprise at least one processor, wherein the at least one processor may cause the second communication node to perform: receiving, from a first communication node, a paging message including information on a total number of trigger messages; periodically receiving, from the first communication node, a trigger message including Msg1 occasion configuration information; and transmitting, to the first communication node, Msg1 including an identifier of the second communication node in response to the trigger message. The trigger message may further include at least one of: information on a current transmission round, information on a time interval until a next trigger message, or information on a number of remaining trigger messages.

The Msg1 occasion configuration information may include at least one of: information on a frequency of a carrier wave, information on a small frequency shift value, information on slots corresponding to a slotted Aloha transmission procedure, information on a time-domain transmission resource, or information on a frequency-domain transmission resource.

The at least one processor may further cause the second communication node to perform: receiving, from the first communication node, Msg2 including the identifier of the second communication node or Msg3 occasion configuration information; and transmitting, to the first communication node, Msg3 in response to the Msg2.

The Msg1 may include information on an energy state change of the second communication node, and in the receiving of the Msg2, the at least one processor may cause the second communication node to perform: configuring a monitoring time of the Msg2 according to the energy state change; monitoring the Msg2 at the configured monitoring time; and receiving the Msg2 at the configured monitoring time.

The at least one processor may further cause the second communication node to perform: determining a duration for maintaining a sleep mode based on a number of trigger messages; and maintaining the sleep mode for the determined duration.

According to the present disclosure, a device can receive a paging message including information on the number of trigger messages from a reader. The device can remain in a standby state for a predetermined duration and save energy by responding to one of the trigger messages depending on the number of received trigger messages. The device can also transmit Msg1 including energy state change information to the reader, which can trigger early transmission of Msg2 from the reader and increase the likelihood of receiving Msg2.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating exemplary embodiments of a communication system including IoT devices.

FIG. 4 is a conceptual diagram illustrating exemplary embodiments of a trigger message transmission method.

FIG. 5 is a conceptual diagram illustrating exemplary embodiments of a signal transmission and reception method in a communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,”etc.).

In the present disclosure, a phrase including “when ˜” may be expressed as a phrase including “based on ˜” or a phrase including “in response to ˜”. In other words, a phrase including “when ˜” may be interpreted as the same as or similar to a phrase including “based on ˜”or a phrase including “in response to ˜”.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

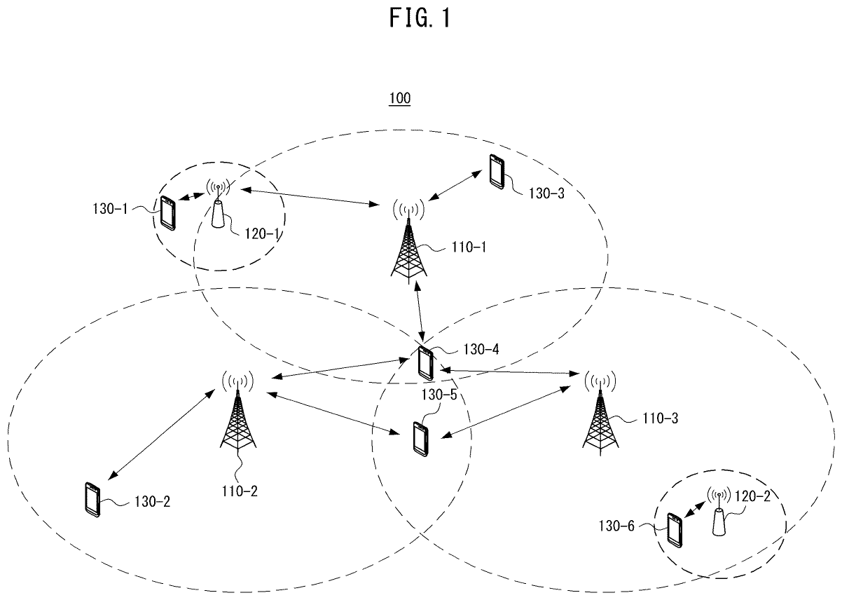

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

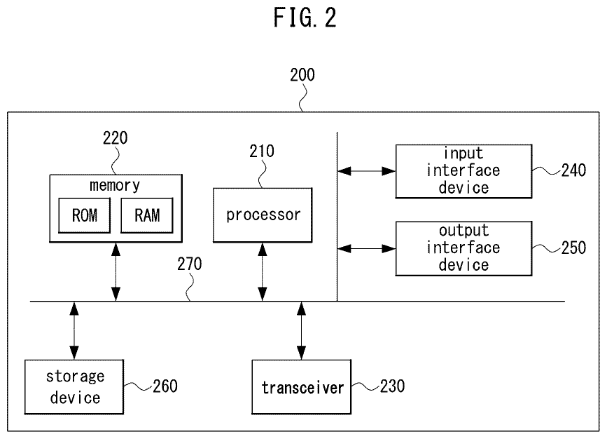

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of user equipments (UEs) 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third UE 130-3, and the fourth UE 130-4 may belong to the cell coverage of the first base station 110-1. Also, the second UE 130-2, the fourth UE 130-4, and the fifth UE 130-5 may belong to the cell coverage of the second base station 110-2. Also, the fifth base station 120-2, the fourth UE 130-4, the fifth UE 130-5, and the sixth UE 130-6 may belong to the cell coverage of the third base station 110-3. Also, the first UE 130-1 may belong to the cell coverage of the fourth base station 120-1, and the sixth UE 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of UE 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding UE 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of UEs 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, a 5G communication system may support a data delivery function according to service characteristics. The 5G communication system and data transmission technology may vary depending on service requirements in order to support the data delivery function according to service characteristics. The 5G communication system may apply technologies required by a considered service while maintaining basic operation procedures or signal structures as much as possible.

The services considered in the present disclosure may be Internet of things (IOT) services such as logistics tracking, process handling, industrial equipment operation monitoring, or equipment control in industries or factories. Additionally, the services considered in the present disclosure may be IoT services applicable across society, such as micro mobility or electric power metering.

IoT devices for such IoT services may be deployed in very large quantities of more than hundreds of billions, considering various applications while further reducing size, complexity, and power consumption. However, due to issues such as maintenance and management, it may be difficult to manually replace or recharge a battery of the IoT device. Therefore, IoT technology may require a new ambient IoT (AIoT) technology in order to support a device without energy storage capability, a device not equipped with a battery, a device that does not require manual battery replacement, or a device that does not require battery recharging.

In such an AIoT network, the IoT device may be a wireless device having lower complexity than a narrowband (NB)-IoT device or a long-term evolution machine type communication (LTE-MTC) device. In addition, the IoT device in the AIoT network may be a wireless device that does not have a battery. Alternatively, the IoT device in the AIoT network may be a wireless device that has a battery with limited capacity.

As described above, the wireless device considered in the present disclosure may operate without a battery. The wireless device considered in the present disclosure may operate in a state where the wireless device is not connected to an external power source. The wireless device considered in the present disclosure may acquire energy necessary for operations by harvesting, collecting, aggregating, or acquiring an energy source from the surrounding environment.

For example, the wireless device considered in the present disclosure may acquire energy necessary for operations from a wireless signal transmitted from a nearby wireless device. The wireless device considered in the present disclosure may backscatter a wireless signal received from another nearby wireless device and transmit the backscattered wireless signal. The wireless device considered in the present disclosure may be defined as an ambient IoT device or terminal that harvests energy from the surrounding environment. The ambient IoT terminal may, for convenience of description, be defined as an IoT device or terminal.

To this end, the present disclosure provides a transmission and reception method and operation procedure in a wireless communication network that can harvest energy and take the harvested energy state into account. The objective of the present disclosure for solving the above-mentioned problem is to propose a signal transmission and reception method and procedure in consideration of an energy harvesting state of a wireless device.

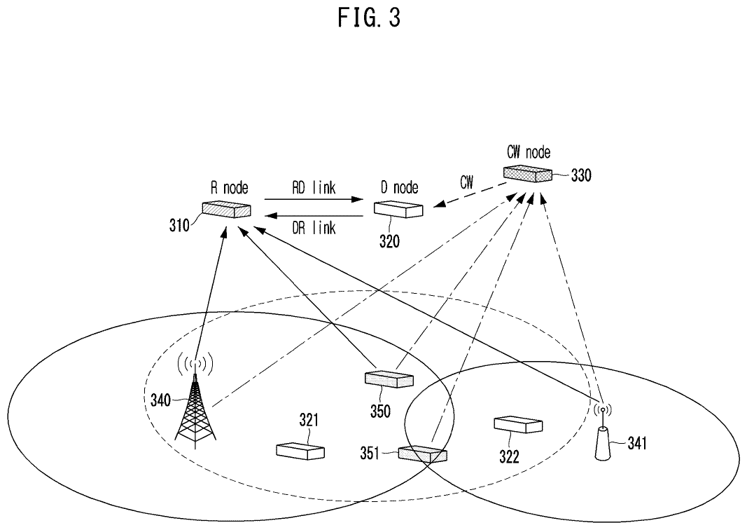

FIG. 3 is a conceptual diagram illustrating exemplary embodiments of a communication system including IoT devices.

Referring to FIG. 3, a communication node 310 may be a device that wirelessly transmits and receives data with an IoT device. The communication node 310 may be defined as a ‘reader’, ‘R node’, or ‘R-node’. A communication node 320 may be an AIoT device and may operate with low power. The communication node 320 may communicate with the reader. The communication node 320 may be defined as an ‘IoT device’, ‘IoT terminal’, ‘IoT node’, ‘I node’, or ‘I-node’. The communication node 320 may be defined as a ‘D node’ or ‘D-node’ as a device. A link from the communication node 310 to the communication node 320 may be referred to as an RI link or an RD link. Conversely, a link from the communication node 320 to the communication node 310 may be referred to as an IR link or a DR link.

A communication node 330 may emit or transmit a carrier wave (CW). The communication node 330 may be defined as a ‘CW-node’, ‘CW node’, ‘CW device’, or ‘CW terminal’. In addition, the communication node 330 may be defined as a carrier wave supplying terminal, a carrier wave terminal, or a carrier wave node. The communication node 330 may transmit the carrier wave to the IoT node. Then, the IoT node may collect, aggregate, or accumulate energy from the carrier wave. Furthermore, the IoT node may backscatter the carrier wave to transmit or provide a signal to the communication node 310. The communication node 310 may receive the signal transmitted through backscattering from the IoT node.

The reader, which is the communication node 310, may be a base station or terminal in the wireless communication network. The terminal may transmit and receive data as being connected with a base station and may refer to a user equipment (UE). The CW node, which is the communication node 330, may be a base station or terminal in the wireless communication network.

An I node 321 may be located at a distance capable of transmitting and receiving data with a base station 340. In such an operating environment, the base station 340 may operate as an R-node or CW-node with respect to the I-node 321. Alternatively, a terminal 350 may perform a role of an R-node or CW-node with respect to the I-node 321. Alternatively, an adjacent other base station may perform a function of an R-node or CW-node with respect to the I-node 321. The present disclosure defines a network environment of operating conditions of the above wireless devices as an ‘in-service condition’.

An I node 322 may be located at a distance not capable of at least transmitting or receiving with the base station 340. The I node 322 may operate with low power. In this case, the I node 322 may attempt to receive data from the base station 340. The I node 322 may transmit a signal having a signal strength equal to or smaller than a certain level. The base station 340 may have difficulty receiving data from the I node 322 without error.

The terminal 350 may perform a role of an R-node capable of transmitting and receiving data with the I node 322. The I node 322 may receive data from the base station 340. The I node 322 may transmit data to the terminal 350. The terminal 350 may receive data from the I node 322 and may deliver the data to the base station 340. Another terminal 351, other than the terminal 350 performing the role of the R-node, may perform a role of a CW-node. Alternatively, the base station 340 may perform a role of a CW-node. Alternatively, the base station 341 may perform a role of a CW-node.

Alternatively, the adjacent other base station 341 may perform a role of an R-node capable of transmitting and receiving data with the I node 322. In such a case, the I node 322 may receive data from the base station 340. Then, the I node 322 may transmit data to the adjacent other base station 341. The adjacent other base station 341 may receive data from the I node 322 and may deliver the received data to the base station 340. The base station 340 may receive the data from the adjacent other base station 341. The terminal 350 may perform a role of a CW-node. The present disclosure may define the above network environment as an ‘out-of-service condition’.

Methods for configuring transmission and reception channels, frequencies, or links of communication nodes in a wireless communication network are described. The wireless communication network may be composed of ‘R node’, ‘I node (or D node)’, and ‘CW node’. The ‘R node’ and ‘CW node’ may be implemented as at least physically the same communication node. The ‘R node’ or ‘CW node’ may be implemented as a base station or terminal. A signal link from the base station to the terminal may be referred to as a downlink, and a signal link from the terminal to the base station may be referred to as an uplink.

In the present disclosure, a link through which the R node transmits a signal to the D node may be defined as an RD link. A link through which the D node transmits a signal to the R node may be defined as a DR link. A link through which the CW-node transmits a signal to the D node may be defined as a CWD link.

In the present disclosure, the RD/DR/CWD link may be described as RD/DR/CWD link transmission or RD/DR/CWD transmission. However, as a detailed distinction, a link may refer to a connection between two nodes. The ‘transmission’ may refer to actual signal transmission performed while occupying wireless resources. For example, the ‘RD transmission’ may refer to a signal or a set of signals transmitted through the RD link during a certain time duration (e.g. a plurality of slots).

In addition, in the present disclosure, transmission resources of the RD/DR/CWD link may refer to a resource region in which transmission can be performed. The RD/DR/CWD transmission may refer to the transmission itself that is actually performed through the resource region. For convenience of description, the present disclosure may assume that RD/DR/CWD transmission is entirely performed over the RD/DR/CWD transmission resource region. In other words, the size or position of the resource region may be assumed to be the same as that of the actual transmission.

In a base station environment operating in Frequency Division Duplex (FDD), an ‘RD transmission’ may be transmitted through a downlink of FDD. When an ‘R node’ that has transmitted the signal performs a role of an ‘R node’ that receives a signal from a ‘D node’, a ‘DR link’ may be configured on the same downlink. Since a D node may have difficulty performing frequency conversion or frequency shift, both an RD link and a DR link may be configured on the same downlink. Here, a ‘CWD link’ may also be configured on the same downlink.

Alternatively, in an environment operating in FDD, an ‘RD transmission’ may be transmitted through an uplink of FDD. When an ‘R node’ that has transmitted the signal performs a role of an ‘R node’ that receives a signal from a ‘D node’, a ‘DR link’ may be configured on the same uplink. Since a D node may have difficulty performing frequency conversion or frequency shift, both an RD link and a DR link may be configured on the same uplink. A ‘CWD link’ may also be configured on the same uplink. Alternatively, when a D node is capable of performing frequency conversion or frequency shift, the ‘RD link’ may be configured on the downlink, and the ‘DR link’ may be configured on the uplink.

### Energy Harvesting

A device may harvest energy through wireless radio signals. The device may harvest energy from another external energy source. The device may include an energy unit, a transceiver, and the like. The energy unit of the device may be a module or a block that performs energy harvesting, and/or may be a module or a block that manages harvested energy. The transceiver may perform an operation of transmitting or receiving a signal. Operations of the transceiver may be limited according to an amount of energy that can be harvested or stored in the energy unit.

A state of the device may be a stop state in which operations are stopped according to an energy criterion. A state of the device may be a sleep state or a standby state in which energy can be charged according to an energy criterion, and subsequently an operation can be performed. According to an operation state, the device may be capable of only transmission or reception. According to an operation state, the device may be capable of both transmission and reception. According to an operation state, the device may be in a state in which no operation can be performed. An energy value, a level, or a threshold that is a criterion of an operation state according to the harvested energy may vary according to a scheme of implementing or configuring the device.

An operation state of the device (or terminal) may be one of an on mode, a sleep mode, or an off mode. In the on mode, the device may be able to transmit and receive signals. In the on mode, the device may be able to store and maintain data or information required for an operation including at least signal transmission and reception in relation to the operation of the device. The data or information may be instantaneous or temporary data or information required for the operation of the device including at least transmission and reception. In the on mode, information related to a time clock or a clock operation of the device may be maintained. The off mode may refer to a state in which signal transmission and reception cannot be performed. In the off mode, the device may maintain at least information required for operations in the device.

In the sleep mode, the device may maintain at least a clock for a minimal purpose. The minimal purpose may be to operate at a specific time in the sleep mode. For example, the device may maintain a clock for an operation of receiving a message delivered at a constant interval, a constant period, or a constant time from a reader.

An energy harvesting level may refer to a level of energy harvested in the device. The energy harvesting level may define an operation state. For example, the energy harvesting level of the device may be less than or equal to an energy harvesting level EngLv_S. In such a case, the device may be in an operation state where both transmission and reception cannot be performed. The energy harvesting level of the device may exceed an energy harvesting level EngLv_R. In such a case, the device may be in an operation state where signal reception can be performed. The energy harvesting level of the device may exceed an energy harvesting level EngLv_T. In such a case, the device may be in an operation state where transmission can be performed. The energy harvesting level of the device may exceed an energy harvesting level EngLv_TR. In such a case, the device may be in an operation state where both transmission and reception can be performed.

A state of transmitting related information to a reader or a network before the device reaches a specific operation state may be defined. For example, an energy harvesting level EngLv_T_Alarm may be less than the energy harvesting level EngLv_T. The energy harvesting level of the device may exceed the energy harvesting level EngLv_T_Alarm. In this case, the energy harvesting level of the device may be close to the energy harvesting level EngLv_T. The energy harvesting level of the device may exceed an energy harvesting level EngLv_S_Alarm. In this case, the energy harvesting level of the device may be close to the energy harvesting level EngLv_S.

Energy harvesting related time information of the device may be defined as an exemplary embodiment related to energy harvesting parameters. The energy harvesting related time information of the device may include information on a time or period required for energy charging. The energy harvesting related time information of the device may include information on a time or period required for energy discharging. The energy harvesting related time information of the device may be defined as one or more combinations among a number of physical reader-to-device channel (PRDCH) receptions or a number of physical device-to-reader channel (PDRCH) transmissions in relation to energy discharging. Alternatively, the energy harvesting related time information of the device may be defined as a number of executions of a specific communication procedure.

The present disclosure describes exemplary embodiments of operations of the device according to an energy state. The device may define an operation state according to a certain reference value of harvested energy. The device may perform a specific operation according to a certain reference value of harvested energy. The device may also deliver information on an operation state according to an energy state to a reader.

In another exemplary embodiment, the device may deliver information on a time at which signal transmission or reception can be performed based on an energy harvesting state to the reader. The device may expect the reader to transmit a message or data based on energy related time information of the device. Alternatively, in another exemplary embodiment, the device may transition an operation state of the device to a state capable of minimizing energy consumption based on information such as a message delivery period or an information delivery time delivered from the reader. Alternatively, the device may transition its state according to a time or a period of a state such as an operation stop, a sleep state, an operation state, or a wake-up state indicated by the reader.

The present disclosure describes more detailed examples regarding operations of the device. More detailed exemplary embodiments regarding operations of the device may be as follows. A reader may transmit PRDCH to a device. The device may receive PRDCH from the reader. The device may transmit a response message for PRDCH or data to the reader. The device may transmit the response message for PRDCH or data to the reader including current energy state information in the response message or data. The reader may receive the response message or data from the device. The reader may receive the response message or data including the current energy state information from the device. The energy state information may include information on an energy harvesting level.

The device may transmit the response message for PRDCH or data to the reader including information on a number of PRDCH transmissions that can be consecutively received in the future. The reader may receive, from the device, the response message or data including information on a number of PRDCH transmissions that can be consecutively received in the future. The device may transmit the response message for PRDCH or data to the reader including information on a number of PDRCH transmissions that can be consecutively transmitted in the future. The reader may receive, from the device, the response message or data including information on a number of PDRCH transmissions that can be consecutively transmitted in the future. The device may transmit the response message for PRDCH or data to the reader including information on a number of PRDCH receptions and PDRCH transmissions that can be consecutively performed in the future. The reader may receive, from the device, the response message or data including information on a number of PRDCH receptions and PDRCH transmissions that can be consecutively performed in the future.

The information on a number of PRDCH receptions and/or PDRCH transmissions that can be performed may be delivered by being included in PDRCH control information or a higher layer message. The number of PRDCH receptions that can be performed may be calculated based on a PRDCH having the longest time length. Alternatively, the number of PRDCH receptions that can be performed may be calculated based on a PRDCH that consumes the most energy for reception. The number of PDRCH transmissions that can be performed may be calculated based on a PDRCH having the longest time length. Alternatively, the number of PDRCH transmissions that can be performed may be calculated based on a PDRCH that consumes the most energy for transmission.

The present disclosure describes more detailed exemplary embodiments according to operations of a reader. More detailed exemplary embodiments according to operations of a reader may be as follows. In an exemplary embodiment, the reader may operate considering an energy state of a device. In an exemplary embodiment, the reader may operate by identifying the energy state of the device. The reader may consider a device that has not performed reception or transmission due to a lack of energy required for reception or transmission, and may repeatedly transmit the same message or the same data to the device.

The reader may repeatedly transmit a message for inventory to the device. The device may repeatedly receive the same message from the reader, and may consume energy in the process of repeatedly receiving. To prevent this, the reader may transmit, to the device, an inventory message including information indicating transmission of the same message in an R2D preamble or PRDCH control information. In an exemplary embodiment, the reader may indicate different transmission information with values from 0 to F for each PRDCH transmission. In addition, the reader may include information indicating a repetition transmission round in the message considering a maximum number R of repeated transmissions, and may transmit the message to the device. When considering a maximum of 4 repeated transmissions, the reader may indicate a transmission round with 2 bits. The device may receive a PRDCH having a PRDCH transmission index value of 0 to F, and may not receive the remaining PRDCHs that are repeatedly transmitted by using the received PRDCH transmission index.

More detailed exemplary embodiments of operations of the reader may be as follows. The reader may provide, to the device, at least one among operation time information, operation period information, or information on a number of PRDCHs to be transmitted, so that the device can transition its state. The operation time information, the operation period information, or the information on a number of PRDCHs to be transmitted may be referred to as ‘operation information’ for convenience. The reader may deliver the operation information to each IoT device through unicast. The reader may deliver the operation information to a plurality of IoT devices through multicast. The reader may deliver the operation information to a plurality of IoT devices through broadcast. A device that receives the operation information may transition a state of the device according to the operation information provided or indicated by the reader. The state of the device may include at least a wake-up state. The state of the device may include at least a sleep mode. In the sleep mode, the device may be capable of only transmission. In the sleep mode, the device may be capable of only reception. In the sleep mode, the device may not be capable of both transmission and reception.

### PRDCH/PDRCH

An RD transmission and/or a DR transmission may include a preamble portion and a data portion. In the time domain, the preamble portion may be configured prior to the data portion in the RD transmission and/or the DR transmission, and the data portion may be configured after the preamble portion. The preamble portion may be configured as a sequence or pattern. The data portion may include physical layer (e.g. layer 1 (L1)) control information. The data portion may include higher layer control information (e.g. radio resource control (RRC) message). The data portion may include a payload of a higher layer. The payload may be an information message to be delivered from the reader to the IoT device. The information message may include an inventory-related request message of a factory (i.e. inventory message). In the present disclosure, the data portion of the RD transmission may be described as PRDCH. In the present disclosure, the data portion of the DR transmission may be described as PDRCH.

### Transmission Intervall

A minimum time interval between an RD transmission and a DR transmission for responding to the RD transmission may be defined as T_R2D_min. A minimum time interval between an RD transmission and a DR transmission after the RD transmission may be defined as T_R2D_min. A minimum time interval between a DR transmission and an RD transmission for responding to the DR transmission may be defined as T_D2R_min. A minimum time interval between a DR transmission and an RD transmission after the DR transmission may be defined as T_D2R min.

A minimum time interval between two different RD transmissions may be defined as T_R2R_min. A minimum time interval between two different DR transmissions may be defined as T_D2D_min. A maximum time interval between an RD transmission and a DR transmission for responding to the RD transmission may be defined as T_R2D_max. A maximum time interval between an RD transmission and a DR transmission after the RD transmission may be defined as T_R2D_max.

A maximum time interval between a DR transmission and an RD transmission for responding to the DR transmission may be defined as T_D2R_max. A maximum time interval between a DR transmission and an RD transmission after the DR transmission may be defined as T_D2R_max. A maximum time interval between two different RD transmissions may be defined as T_R2R_max. A maximum time interval between two different DR transmissions may be defined as T_D2D_max.

The above-described values may be configured equally for all devices belonging to the same reader. Alternatively, the above-described values may be configured equally for reader(s) and devices in a network including one or more readers. In another example, the above-described values may be configured differently according to devices belonging to the same reader. Alternatively, the above-described values may be configured differently according to reader(s) and devices in a network including one or more readers. Alternatively, the above-described values may be configured differently according to a type of message.

In relation to a start time of a DR transmission, in an exemplary embodiment, the device may start the DR transmission in a time duration between T_R2D_min and T_R2D_max after an RD transmission. In another exemplary embodiment, L1 control information may include at least information on T_R2D indicating a time of a DR transmission after an RD transmission. T_R2D may be greater than T_R2D_min, or may be greater than or equal to T_R2D_min. The device may start the DR transmission based on the time indicated as T_R2D.

The present disclosure describes exemplary embodiments regarding a method of starting a DR transmission in a time duration between T_R2D_min and T_R2D_max. The device may divide the time duration between T_R2D_min and T_R2D_max into uniform unit durations, and may perform the DR transmission in one unit duration. The unit duration may be assumed as an IoT slot. A length of the IoT slot may be assumed as a length of a specific DR transmission. The length of the IoT slot may be equal to, for example, a length of Msg1 of a random access procedure.

A position of an IoT slot for the DR transmission, that is the one unit duration, may be randomly determined. The position of the slot may have an index value sequentially increasing from T_R2D_min. The index value may be used in a subsequent corresponding RD transmission or DR transmission. For example, in a random access procedure, the device may transmit Msg1 including a selected index to the reader by selecting one index for Msg1 transmission.

The reader may receive Msg1 including the selected index from the device. The reader may transmit Msg2 to the device. The reader may transmit Msg2 to the device including the index received through Msg1. The device may receive Msg2 including the index, and may confirm reception of Msg1 at the reader based on the received index. As described above, the reader may transmit Msg2 including the index to the device to inform the device of the reception of Msg1.

Msg2 may include information confirming reception at the reader. Alternatively, when Msg1 receptions from different devices are confirmed based on Msg2, the device may apply the received index to determine a resource position for Msg3 transmission. The device may determine a resource position for Msg3 transmission considering the position index of the IoT slot randomly selected. In the present disclosure, transmission of Msg1 or Msg3 may refer to a DR transmission in which the devices deliver a PDRCH including Msg1 or Msg3 to the reader. In addition, transmission of a trigger message or Msg2 may refer to an RD transmission in which the reader delivers a PRDCH including the trigger message or Msg2 to the devices.

### Inventory Procedure or Random Access Procedure

The present disclosure describes methods and procedures of responding by one or more devices according to a request of the reader. The process may be referred to as an inventory process. In the inventory process, the reader may transmit a request message to the devices. In such an inventory process, the request message of the reader may be defined as a paging message, a trigger message, or Msg0. The device may receive the request message from the reader and may transmit a response message to the reader regarding the request message. The response message transmitted by the device in response to Msg0 of the reader may be defined as Msg1. The random access procedure may start from Msg1 transmission of the device.

Devices may perform access operations as contention-based access in the random access procedure. A device may transmit Msg1 to the reader. The reader may receive Msg1 and may transmit Msg2 to the device in response to or corresponding to the received Msg1. The device may receive Msg2 and may transmit Msg3 to the reader in response to or corresponding to the received Msg2. The reader may receive Msg3 and may transmit Msg4 to the device in response to or corresponding to the received Msg3. Msg4 may include information on a scheduled resource. The device may transmit Msg5 including response information or response data regarding the inventory request to the reader using the scheduled resource indicated by Msg4. The reader may receive Msg5 including response information or response data regarding the inventory request from the device.

Msg1 may include device information or device ID information. Msg1 may be a message used for random access. Devices may perform DR transmissions including Msg1 in a contention-based manner. Each of the devices may configure Msg1 with one sequence randomly selected among designated sequences and may transmit Msg1. Msg2 may include an ID assigned to the device for confirmation of the sequence and recognition between the reader and the device. Msg4 may include configuration information on a resource in which information on the inventory request can be transmitted from the device.

### Resource Configuration for a Random Access Procedure and Resource Selection Method of a Device

Transmission opportunity resources or occasions for a random access procedure may be configured in the time domain and/or frequency domain. The reader may deliver, to the devices, information on transmission opportunity resources or occasions for the random access procedure by including it in a paging message or Msg0. The devices may receive, from the reader, the message including the transmission opportunity resources or occasions for the random access procedure.

Each of the devices may select an occasion among the occasions and may transmit Msg1 to the reader through the selected occasion. The reader may receive Msg1 through the occasion selected among the occasions. The device may transmit Msg1 to the reader according to a slotted-Aloha scheme. A slot may refer to a transmission time length of Msg1. The device may transmit, to the reader, Msg1 including a sequence randomly selected among available sequences as a DR transmission. The reader may receive, from the device, Msg1 including the randomly selected sequence. Msg1 may include ID information or address information of the device.

The reader may transmit trigger messages at a constant period during a time duration. The trigger message may include information on a transmission time of a next trigger message. The trigger message may include at least one among a total number of transmissions of the same trigger message, an order of a current message among the total number of transmissions, and information on a time interval to a next trigger message.

In another example, the paging message and the trigger message may be configured for different purposes. The paging message may include information or a message for initiating an inventory procedure. The reader may transmit the trigger message to cause the device to determine a time for performing Msg1 transmission. The reader may transmit one paging message to the device and then may transmit one or more trigger messages to the device. The paging message may include a number of trigger messages transmitted after the paging message.

The paging message may include configuration information of resources configured to allow Msg1 to be transmitted according to the trigger message (a number of time-domain resources and/or a number of frequency-domain resources). Alternatively, each of the trigger messages may include configuration information of resources configured to allow Msg1 to be transmitted immediately thereafter by the device (a number of time-domain resources and/or a number of frequency-domain resources).

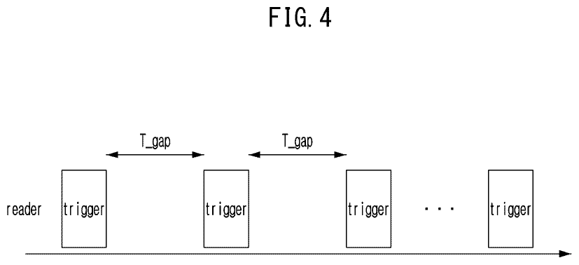

FIG. 4 is a conceptual diagram illustrating exemplary embodiments of a trigger message transmission method.

Referring to FIG. 4, a reader may repeatedly transmit A trigger messages to the device at intervals of T_gap. The device may repeatedly receive the trigger messages from the reader at intervals of T_gap. T_gap may not be a value of a fixed interval, may refer to a time difference between adjacent trigger transmissions, and may be a real number. The trigger message may include information on the total number A of trigger messages, a current transmission round #a+n, and information on a time interval T_gap to a next trigger message. Each of A, a, or n may be a positive integer.

In another example, the trigger message may include information on a number of remaining trigger messages including the current trigger message. Alternatively, the trigger message may include a number of remaining trigger messages from the next trigger message. The trigger messages may be the same trigger messages. The device may receive one among the same trigger messages. The device may transmit a response to the received trigger message to the reader. The device may not respond to other trigger messages.

The device may receive the trigger message from the reader and may perform an inventory procedure according to the received trigger message. After completing the inventory procedure, the device may not receive a trigger message for a certain time duration. This may mean that the device may minimize energy consumption and may transition to a state in which transmission and reception functions are turned off for energy harvesting or to a sleep operation mode.

The device that receives the trigger message may perform a DR transmission of Msg1 to the reader. The reader may receive Msg1 from the device. The reader may transmit Msg2 to the device as a response to Msg1. The device may receive Msg2, which is a response to Msg1, from the reader. Before transmitting a Msg3 PDRCH at the device, the reader may transmit a trigger message to the device.

The device may receive the trigger message from the reader. The device may not transmit Msg1 again in response to the received trigger message. The device may receive, from the reader, Msg2 corresponding to Msg1 transmitted by the device. The device may not respond or correspond to another trigger message for another inventory procedure transmitted by the reader until the device completes the inventory procedure.

The reader may transmit the trigger message N times. The trigger message may include information on N transmissions. N may be a positive integer. The trigger message may include information such as a total number of transmissions and/or a remaining number of transmissions and/or a current transmission round. The device that receives the trigger message may perform a response or inventory procedure only once with respect to the total N trigger messages.

The device that completes the inventory procedure during remaining trigger messages among N transmissions and an inventory time corresponding thereto may transition to the standby state or the sleep state and may minimize energy consumption. Devices that receive the trigger message may perform a DR transmission of PDRCH including Msg1 as a response signal. The reader may transmit, to the devices, a trigger message including resource configuration information or occasion configuration information to be used for Msg1 transmission.

Msg1 transmission resource or occasion configuration information included in the paging message may include frequency-related information of a carrier wave (CW) or a small frequency shift value. The Msg1 transmission resource or occasion configuration information may include information on slots corresponding to a slotted-Aloha transmission procedure. The information on slots may include a total number of slots and/or a start time of the first slot and/or a time length of a slot and/or information on a start time and an end time at which the slots are configured. The Msg1 transmission resource or occasion configuration information may include a number X of transmission resources in the time domain and/or a number Y of transmission resources in the frequency domain. X and Y may be positive integers.

When X is set to 2 or more, a time offset between DR transmissions defined as T_D2D may be defined between respective time-domain resources. When X is set to 2, T_D2D may be a time offset between a time-domain resource of X=1 and a time-domain resource of X=2. More specifically, T_D2D may be a time difference from a start time of the time-domain resource of X=1 to a start time of the time domain of X=2. Alternatively, T_D2D may be a time difference from an end time of the time-domain resource of X=1 to the start time of the time domain of X=2.

The device may receive, from the reader, information on the start time (e.g. T_MSG1st) of the time-domain resource of X=1 and information on T_D2D. The reader may include, in the Msg1 transmission resource configuration information, the start time of the first time-domain resource for Msg1 (e.g. T_MSG1st) and information on the time difference T_D2D as Msg1 resource configuration information data or DR transmission scheduling information, and may transmit the Msg1 transmission resource configuration information. The device may attempt MSG1 transmission at the time T_MSG1st. The device may attempt Msg2 transmission at a time (T_MSG1st+T_D2D). The device may determine a transmission attempt randomly.

The reader may include, in the trigger message, time offset information indicating a start time for each of X time-domain resources. Alternatively, the reader may include, in PRDCH for transmitting the trigger message, time offset information indicating a start time for each of X time-domain resources. The reader may include, in the trigger message, information indicating T_R2D_min and/or T_R2D_max for each of X time-domain resources. Alternatively, the reader may include, in PRDCH for transmitting the trigger message, information indicating T_R2D_min and/or T_R2D_max for each of X time-domain resources.

The first time-domain resource may be configured after a predetermined time offset from an end time of an RD transmission including the trigger message. X resources may be configured in consideration of a Msg1 transmission length of a constant length. A chip duration of Msg1 PDRCH may be configured by the longest chip duration index value or the lowest chip duration index value among configurable chip durations. The devices may determine start times and end times of X time-domain resources through a designated start time of the first Msg1 transmission resource and a designated Msg1 length.

The first time-domain resource may be configured after a predetermined time offset from an end time of an RD transmission including the trigger message. X resources may be configured in consideration of a Msg1 length determined from scheduling information of a Msg1 PDRCH configured in PRDCH control information. The devices may determine start times and end times of X time-domain resources based on a designated start time of the first Msg1 transmission resource and a Msg1 length determined from scheduling information of the Msg1 transmission PDRCH.

From the end time of the RD transmission including the trigger message, the device may determine remaining X-1 start times in consideration of the transmission length of Msg1. The devices may determine start times and end times of X time-domain resources through information on the start time of the first Msg1 transmission resource configured from PRDCH and the designated Msg1 length, or through a Msg1 length determined from scheduling information of Msg1 PDRCH in PRDCH control information.

The reader may indicate, to the device, a start time of the first Msg1 transmission resource and start time(s) of another resource or remaining X-1 resources from the end time of the RD transmission including the trigger message. The start time(s) of another resource or remaining X-1 resources may be start time(s) calculated based on the start time of the first Msg1 transmission resource. Information on start times for two resources may be included in control information of PRDCH that transmits the trigger message. The reader may include information on start times for two resources in the first paging message for performing inventory, and deliver the information on the start times to the terminal to indicate the start times for the two resources to the terminal. The device may determine a start time of a resource for transmitting Msg1 from the information on the start times for the two resources.

In Msg1 transmission, unit Msg1 transmission resources (e.g. one slot per CW) may have indexes for X×Y resources, arranged either in a frequency-time order (where frequency may refer to a CW frequency or a small frequency shift, and time refers to a slot) or in a time-frequency order. An index designation order may be assumed to be known to both the reader and the devices.

Each device may select one among multiple unit resources and may transmit Msg1 to the reader using the selected resource. Msg1 may include device ID information capable of distinguishing each device. The reader may receive Msg1 from the device and may identify a device ID and index information of the Msg1 unit resource in the received Msg1. The reader may transmit Msg2 corresponding to the identified Msg1 to the device. The device may receive Msg2 from the reader.

In a first exemplary embodiment, Msg2 may be configured as a Msg2 corresponding to each Msg1. Msg2 may be sequentially transmitted for each CW frequency with respect to Msg1 of each device. Msg2 may be transmitted according to time (slot) information of the index in which Msg1 of each device is transmitted, or according to an order corresponding to the index.

In a second exemplary embodiment, one Msg2 may include Msg2 information corresponding to one or more Msg1s. Msg2 may include device IDs corresponding to identified Msg1s and/or Msg3 transmission resource information of each device ID and/or Msg3 transmission time information of each device and/or Msg3 transmission order of each device ID or sequential device ID information according to a Msg3 transmission order.

In other words, according to the exemplary embodiments, the reader may transmit, to the devices, PRDCH of Msg2 corresponding to each successfully received Msg1 among X×Y possible resources. The reader may transmit Msg2 to the devices according to an order of designated indexes. The reader may transmit up to X×Y PRDCHs of Msg2. Hereinafter, this may be defined and described as ‘Msg2 transmission method-1’.

The reader may transmit, to the device, one PRDCH including Msg2 or Msg2s corresponding to Msg1(s) successfully received in Y frequency-domain resources for each of X time-domain resources. The reader may transmit up to X PRDCHs of Msg2(s) to the device. Hereinafter, this may be defined and described as ‘Msg2 transmission method-2’. The reader may transmit, to the device, one PRDCH including Msg2 or Msg2s corresponding to Msg1(s) successfully received among all of the X×Y resources. The reader may transmit at most one PRDCH of Msg2(s) to the device. Hereinafter, this may be defined and described as ‘Msg2 transmission method-3’.

In the above examples, the reader may transmit, to the device, Msg2 PRDCH including information that can be identified by each of the devices that transmitted Msg1 (e.g. device ID or Msg1 transmission resource position). Alternatively, the reader may include information that can be identified by each of the devices that transmitted Msg1 in PDRCH control information and the like and may transmit the information.

The device may monitor or prepare for reception of Msg2 PRDCH based on an end of the last resource among X time-domain resources indicated or configured by the reader for Msg1 transmission. The reference time may be defined as ‘Msg2 monitoring reference time’. The device may expect to receive, from the reader, Msg2 corresponding to Msg1 transmitted by the device from the Msg2 monitoring reference time to the time T_D2R_max. T_D2R_max may indicate a time duration including a transmission time of one or more possible RD transmissions that transmit Msg2 PRDCH and/or a transmission time of an Msg3 PDRCH DR transmission.

When X=1 or when the reader transmits Msg2 PRDCH according to Msg2 transmission method-3, T_D2R_max may indicate a time duration including a single RD transmission time or an RD reception time for Msg2 PRDCH. The RD transmission time may be a time duration that considers a certain time interval after confirmation of Msg1 reception until the start time of RD transmission, from the perspective of the reader. The RD transmission time may be a time duration that considers a certain time interval after confirmation of Msg1 reception and further considers a portion of signal propagation time until the start time of RD transmission, from the perspective of the reader. The RD reception time may be a time duration, from the perspective of the device, that considers a certain time interval after completion of PDRCH transmission of Msg1 delivery until the time of starting to receive the RD transmission.

When the reader transmits Msg2 PRDCH according to Msg2 transmission method-1 or Msg2 transmission method-2, devices that performed Msg1 transmission in time resources other than the first time resource among X time resources may modify or update the Msg2 monitoring reference time to an end time of the Msg2 PRDCH RD transmission. T_D2R_max may be a time duration including a transmission time of the Msg2 PRDCH RD transmission and/or a transmission time of an Msg3 PDRCH DR transmission.

The device may fail to receive, from the reader, Msg2 corresponding to Msg1 transmitted by the device from the Msg2 monitoring reference time to the time T_D2R_max. In such a case, the device may determine to restart the inventory procedure or the random access procedure. A device that receives Msg2 may transmit Msg3 to the reader. The device may transmit Msg3 in a DR transmission resource for Msg3 transmission configured or scheduled by Msg2. Exemplary embodiments of Msg3 transmission may be as follows.

In a first exemplary embodiment, the device may transmit Msg3 in a transmission resource corresponding to an index used for Msg1 transmission after receiving Msg2. The correspondence may refer to the same resource region or the same occasion. The reader may not include resource configuration information for Msg3 in Msg2. The reader may transmit Msg2 to the device that does not include resource configuration information for Msg3. The device may receive, from the reader, Msg2 that does not include resource configuration information for Msg3. When the device is not able to identify resource configuration information for Msg3 in PRDCH including Msg2, the device may transmit Msg3 using the resource in which Msg1 has been transmitted.

When the device identifies activation of an indicator that does not designate resource configuration information for Msg3 in PRDCH including Msg2, the device may transmit Msg3 using the resource in which Msg1 has been transmitted. When the device identifies the indicator that does not designate resource configuration information for Msg3 in PRDCH including Msg2, the device may transmit Msg3 using the resource in which Msg1 has been transmitted. The reader may transmit, to the device, Msg2 including information capable of identifying the device that transmitted Msg1.

The device may receive, from the reader, Msg2 including information capable of identifying the device that transmitted Msg1. The information capable of identifying the device that transmitted Msg1 may be a device ID. The information capable of identifying the device that transmitted Msg1 may be information on a resource region in which Msg1 has been successfully received. The information capable of identifying the device that transmitted Msg1 may be information on an occasion. Accordingly, each device that transmitted Msg1 may confirm successful transmission of Msg1 from Msg2 transmitted by the reader. The device that has received Msg2 may transmit Msg3 in the same resource, the same resource position, or the same occasion position in which Msg1 has been transmitted.

A second exemplary embodiment may correspond to a case in which the RD transmission of Msg2 in the first exemplary embodiment is terminated at each device. Each device may perform a DR transmission for Msg3. During an RD transmission and/or a DR transmission for Msg2 and/or Msg3, the reader may first transmit a trigger message requiring repeated transmission. A device that has not yet received Msg2 may assume that Msg1 due to the previous trigger message has not been received at the reader, and may perform the inventory process again.

A third exemplary embodiment may correspond to a case in which the device may perform Msg3 DR transmission using a resource for Msg3 transmission of each device designated in the second exemplary embodiment of Msg2. For example, each device may perform Msg3 DR transmission considering a constant time offset in an order corresponding to an order of each device configured in Msg2.

The present disclosure describes Msg3 transmission in greater detail according to Msg2 transmission methods. The reader may transmit Msg2 by Msg2 transmission method-1. Each device that has transmitted Msg1 may receive each Msg2 PRDCH. When the device is able to identify information on itself in the received Msg2 PRDCH, the device may transmit, to the reader, a PDRCH including Msg3 at a DR transmission time. The device may subsequently transmit the PDRCH to the reader after receiving the PRDCH.

The DR transmission time may be designated by an arbitrary time interval based on a time of receiving the PRDCH. Alternatively, the reader may deliver, to the device, a DR transmission time in related scheduling information of Msg2 PRDCH. The device may receive the Msg2 PRDCH including the DR transmission time, and may transmit a PDRCH to the reader at the received DR transmission time. The reader may transmit, to one or more devices, a Msg2 PRDCH including scheduling information for allowing the one or more devices to transmit Msg3 PDRCH(s) multiplexed in the frequency domain at arbitrary times. The device may receive the Msg2 PRDCH including the scheduling information for allowing the one or more devices to transmit Msg3 PDRCH(s) multiplexed in the frequency domain at an arbitrary time.

The present disclosure describes a case in which the reader transmits Msg2 by Msg2 transmission method-2. The reader may transmit, to devices, up to X Msg2 PRDCHs corresponding to X time-domain resources. The reader may transmit X PRDCHs to the devices after receiving Msg3 PDRCH(s) corresponding to the respective Msg2 PRDCHs. Each of the devices that has transmitted Msg1 may receive Msg2 PRDCH from the reader. When the device is able to identify information on itself in the received Msg2 PRDCH, the device may subsequently transmit, at a DR transmission time, a PDRCH including Msg3 after receiving PRDCH.

The DR transmission time may be designated by an arbitrary time interval based on a time of receiving the PRDCH. Alternatively, the reader may deliver, to the device, a DR transmission time in related scheduling information of Msg2 PRDCH. The device may receive the Msg2 PRDCH including the DR transmission time, and may transmit a PDRCH to the reader at the received DR transmission time.

When designated by an arbitrary time interval, the devices may transmit Msg3 PDRCH to the reader in a resource identical to a frequency-domain resource used for Msg1 transmission. The reader may deliver, to each device, frequency-domain resource information as scheduling information in Msg2 PRDCH. Each device may transmit Msg3 PDRCH in a scheduled frequency-domain resource. The reader that receives Msg3 PDRCH(s) may transmit Msg2 PRDCH to the devices through a next Msg1 time-domain resource. The reader may receive Msg3 PDRCH(s) corresponding to Msg2 PRDCH from the devices.

For Msg3 transmission corresponding to each of the X Msg2 PRDCH transmissions, as an exemplary embodiment, the time resource of the PDRCH for Msg3 transmission may be configured to be a single resource. In an exemplary embodiment, a transmission resource of PDRCH for Msg3 transmission corresponding to Msg2 PRDCH may be configured with one time resource and Y frequency resources. A device that has transmitted Msg1 may transmit Msg3 in a resource used for Msg1 transmission among Y frequency resources. For Msg3 transmission corresponding to each of the X Msg2 PRDCH transmissions, as an exemplary embodiment, the time and frequency resources of the PDRCH for Msg3 transmission may be configured as single resources. In other words, up to Y Msg3 PDRCH transmissions may be configured after the Msg2 PRDCH. The device may transmit Msg3 PDRCH based on start position (or time) information of a Msg3 PDRCH time resource configured in Msg2 PRDCH.

The present disclosure describes a case in which the reader transmits Msg2 by Msg2 transmission method-3. Each of the devices that has transmitted Msg1 may receive each Msg2 PRDCH. When the device is able to identify information on itself in the received Msg2 PRDCH, the device may transmit, to the reader, a PDRCH including Msg3 at a DR transmission time. The device may subsequently transmit the PDRCH to the reader after receiving the PRDCH.

The DR transmission time may be designated by an arbitrary time interval based on a time of receiving the PRDCH. Alternatively, the reader may deliver, to the device, a DR transmission time in related scheduling information of Msg2 PRDCH. The device may receive the Msg2 PRDCH including the DR transmission time, and may transmit a PDRCH to the reader at the received DR transmission time.

The reader may transmit, to one or more devices, a Msg2 PRDCH including scheduling information for allowing the one or more devices to transmit Msg3 PDRCH(s) multiplexed in the frequency-domain at an arbitrary time. The device may receive the Msg2 PRDCH including scheduling information for allowing the one or more devices to transmit Msg3 PDRCH(s) multiplexed in the frequency-domain at an arbitrary time.

Msg2 transmission method-1, Msg2 transmission method-2, and/or Msg2 transmission method-3 may be dynamically configured according to an indication of the reader. Msg2 PRDCH control information or a Msg2 message may include an indicator for a transmission method. The Msg2 message may include only one device ID information of a device that has successfully delivered Msg1. In such a case, one Msg3 transmission according to Msg2 transmission method-1 may be configured.

The Msg2 message may include one or more pieces of device ID information of devices that have successfully delivered Msg1. In such a case, Msg3 transmission according to Msg2 transmission method-2 may be configured. A number of device IDs may be greater than one and less than Y. The device may identify information of one or more device IDs in Msg2. In such a situation, the device may determine that Msg3 transmission resources according to Msg2 transmission method-2 are configured.

The device may transmit Msg3 in a frequency resource used for Msg1 transmission. A start time of a time resource for Msg3 transmission may be included in control information of Msg2 PRDCH. The start time of the time resource for Msg3 transmission may be included in a paging message. The start time of the time resource for Msg3 transmission may apply the same time offset as the time resource for the first Msg1 transmission.

In the inventory process, whether message transmission or reception of the device is possible may vary during the random access procedure according to a harvested energy state or level. The present disclosure describes, by exemplary embodiments, a procedure considering an energy state of the device, a method of delivering a request message at the reader, a method in which the device can receive the request message and deliver a response message, and the like.

The reader may transmit Msg0 to the devices without special consideration for energy states of the devices. The devices may receive Msg0 from the reader. Each of the devices may transmit Msg1 as a response to Msg0 according to its energy state. Alternatively, each of the devices may not be able to transmit Msg1 as a response to Msg0 according to its energy state.

A device in an on-state may transmit Msg1 to the reader in response to Msg0. The reader may receive Msg1 from the device. The reader, upon receiving Msg1, may transmit Msg2 to the device as a response corresponding to Msg1 within a time duration between T_D2R_min and T_D2R_max. The device may receive Msg2 from the reader.

The present disclosure describes exemplary embodiments of operations in certain states after a device transmits Msg1 as a response to Msg0. For a case where a device is able to transmit Msg1 but does not have a sufficient energy to receive Msg2, the present disclosure describes exemplary embodiments regarding operations of the reader and/or the device. The device may transition its state to a sleep mode or an off mode after transmitting Msg1.

The reader may obtain in advance information on a state transition related to energy harvesting and consumption of a device. The reader may obtain information on an energy shortage state in which the device is unable to receive Msg2 when the device transmits Msg1. The device may provide the reader with information on an energy shortage state for receiving Msg2 after transmitting Msg1 when initially approaching or accessing the reader. The reader may receive, from the device initially approaching or accessing the reader, information on an energy shortage state for receiving Msg2 after transmitting Msg1.

The reader may configure different T_D2R_min and/or T_D2R_max for devices. The reader may deliver information on different T_D2R_min and/or T_D2R_max to the devices. Alternatively, the reader may configure different T_D2R_min and/or T_D2R_max for the devices. The device may expect to receive Msg2 corresponding to Msg1 from the reader at a time within the configured time duration between T_D2R_min and T_D2R_max.

For a case where a device is able to transmit Msg1 but does not have a sufficient energy to receive Msg2, the present disclosure describes operations of the reader and/or the device according to another exemplary embodiment. The device may transition its state to a sleep mode or an off mode after transmitting Msg1.

The reader may know in advance information on a state transition related to energy harvesting and consumption of a device. The reader may obtain information on an energy shortage state in which the device is unable to receive Msg2 when the device transmits Msg1. The device may provide the reader with information on an energy shortage state for receiving Msg2 after transmitting Msg1 when initially approaching or accessing the reader. The reader may receive, from the device initially approaching or accessing the reader, information on an energy shortage state for receiving Msg2 after transmitting Msg1. In such a case, the reader may acquire device ID information or an indicator from Msg1. The reader may identify or distinguish the transmitter of Msg1 from the device ID or the indicator. The reader may transmit Msg2 to the device by considering different T_D2R_max according to the identified device ID.

For a case where a device is able to transmit Msg1 but does not have a sufficient energy to receive Msg2, the present disclosure describes operations of the reader and/or the device according to another exemplary embodiment. The device may transition its state to a sleep mode or an off mode after transmitting Msg1. The device may transmit at least one among information, an indicator, or a message related to such energy state change to the reader by including it in Msg1. The reader may receive Msg1 including at least one among the information, the indicator, or the message related to such energy state change from the device.

The device may indicate at least one among the information, the message, or the control information indicating a state in which Msg2 cannot be received immediately using bits of a predetermined length. If only whether reception can be performed is indicated, the device may indicate a state in which Msg2 cannot be received immediately by using one bit. Alternatively, the device may indicate a state in which Msg2 cannot be received immediately using one bit as information related to Msg0 transmission.

For example, the reader may transmit Msg0 with a Rep_Msg0 period. The device may inform the reader that Msg2 cannot be received before or after the next n-th Msg0 based on the period. The reader that receives Msg1 may transmit Msg2 to the device before transmitting the next n-th Msg0. Alternatively, the reader may transmit Msg2 to the device after transmitting the next n-th Msg0. n may be 1. The n-th Msg0 may be the same message as Msg0. n may be defined differently depending on the device.

The reader may determine the n-th Msg0 for transmitting Msg2 according to the energy state change related information or indicator included in Msg1. The device may know in advance transmission times of the next Msg0 or the next N Msg0s delivered through an RRC higher layer message, L1 control information, or Msg0. The device may prepare to receive Msg2 after harvesting energy in a sleep mode or an off mode after energy consumption.

The present disclosure describes exemplary embodiments of operations under the following conditions after a device is able to receive Msg2 and transmits Msg3. For a case where a device is able to transmit Msg3 but does not have a sufficient energy to receive Msg4, the present disclosure describes exemplary embodiments of operations of the reader and/or the device. The device may transition its state to a sleep mode or an off mode after transmitting Msg3.

The reader may know in advance state change information related to energy harvesting and consumption of the device. The reader may know information on an energy shortage state for receiving Msg4 when the device transmits Msg3. The device may provide the reader with information on an energy shortage state for receiving Msg4 after transmitting Msg3 when initially approaching or accessing the reader. The reader may receive, from a device initially approaching or accessing the reader, information on an energy shortage state for receiving Msg4 after transmitting Msg3. The reader may configure different T_D2R_min and/or T_D2R_max for devices. The reader may deliver information on different T_D2R min and/or T_D2R_max to the devices. Alternatively, the reader may configure different T_D2R_min and/or T_D2R_max for the devices. The device may expect to receive Msg2 corresponding to Msg1 from the reader at a time within the configured time duration between T_D2R_min and T_D2R_max.

For a case where a device is able to transmit Msg3 but does not have a sufficient energy to receive Msg4, the present disclosure describes operations of the reader and/or the device according to another exemplary embodiment. The device may transition its state to a sleep mode or an off mode after transmitting Msg3.

The reader may know in advance state change information related to energy harvesting and consumption of the device. The reader may know information on an energy shortage state for receiving Msg4 when the device transmits Msg3. The device may provide the reader with information on an energy shortage state for receiving Msg4 after transmitting Msg3 when initially approaching or accessing the reader. The reader may receive, from a device initially approaching or accessing the reader, information on an energy shortage state for receiving Msg4 after transmitting Msg3. In such a case, the reader may acquire device ID information or an indicator from Msg3. The reader may identify or distinguish the transmitter of Msg3 from the device ID or the indicator. The reader may transmit Msg4 to the device by considering different T_D2R_max according to the identified device ID.

For a case where a device is able to transmit Msg3 but does not have a sufficient energy to receive Msg4, the present disclosure describes operations of the reader and/or the device according to another exemplary embodiment. The device may transition its state to a sleep mode or an off mode after transmitting Msg3. The device may transmit at least one of information, an indicator, or a message related to such energy state change to the reader by including it in Msg3. The reader may receive Msg3 including at least one of the information, the indicator, or the message related to such energy state change from the device.

The device may indicate at least one of the information, message, or control information indicating the state in which Msg4 cannot be received immediately using bits of a predetermined length. If only whether reception can be performed is indicated, the device may indicate the state in which Msg4 cannot be received immediately by using one bit. Alternatively, the device may indicate the state in which Msg4 cannot be received immediately using one bit as information related to Msg0 transmission.

For example, the reader may transmit Msg0 with a Rep_Msg0 period. The device may inform the reader that Msg4 cannot be received before or after the next n-th Msg0 based on the period. The reader that receives Msg3 may transmit Msg4 to the device before transmitting the next n-th Msg0. Alternatively, the reader may transmit Msg4 to the device after transmitting the next n-th Msg0. n may be 1. The n-th Msg0 may be the same message as Msg0. n may be defined differently depending on the device. Alternatively, the reader may determine n based on energy state change related information or an indicator included in Msg3. The device may know in advance transmission times of the next Msg0 or the next N Msg0s delivered through an RRC higher layer message, L1 control information, or Msg0. The device may prepare to receive Msg4 after harvesting energy in a sleep mode or an off mode after energy consumption.

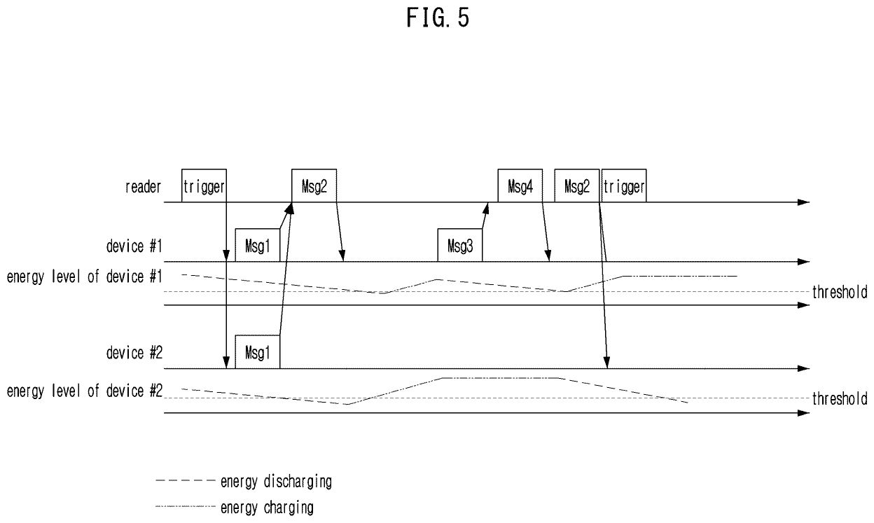

FIG. 5 is a conceptual diagram illustrating exemplary embodiments of a signal transmission and reception method in a communication system.

Referring to FIG. 5, a device among device 1 or device 2 may be able to transmit Msg1 but may not have a sufficient energy to receive Msg2. The device may transition its state to a sleep mode or an off mode after transmitting Msg1. The device may transmit at least one of information, an indicator, or a message related to such energy state change to the reader by including it in Msg1. The reader may receive Msg1 including at least one of the information, the indicator, or the message related to such energy state change from the device.

The device may indicate at least one of the information, the message, or control information indicating a state in which Msg2 cannot be received immediately using bits of a predetermined length. If only whether reception can be performed is indicated, the device may indicate the state in which Msg2 cannot be received immediately by using one bit.

The device may request the reader to transmit Msg2 after a duration corresponding to N times a reference time length T_ref. For example, the duration of N times the specific reference time length T_ref may represent a waiting time for Msg2 transmission or an offset time. The device may transmit Msg1 including N to the reader. The reader may receive Msg1 including N from the device. In other words, the device may transmit a value of N to the reader by including the value of N in a message or control information of a DR PDRCH for Msg1 in consideration of an energy harvesting state. The reader may receive the message or control information of the DR PDRCH for Msg1 including the value of N from the device.

N may be 1. If information bits for N are configured as a single bit, the reader may interpret the one-bit information for N as information on whether to apply an offset. T_ref may be defined in advance between the reader and the device and may be shared between the reader and the device. The reader may deliver T_ref to the device through an RRC higher layer message. The device may receive the RRC higher layer message including T_ref from the reader.

A device among device 1 or device 2 may be able to transmit Msg3 but may not have a sufficient energy to receive Msg4. The device may change the state to a sleep mode or an off mode after transmitting Msg3. The device may transmit at least one of information, an indicator, or a message related to such energy state change to the reader by including it in Msg3. The reader may receive Msg3 including at least one of the information, the indicator, or the message related to such energy state change from the device.

The device may indicate at least one of the information, the message, or the control information indicating the state in which Msg4 cannot be received immediately using bits of a predetermined length. If only whether reception can be performed is indicated, the device may indicate the state in which Msg4 cannot be received immediately by using one bit.

The device may request Msg4 transmission to the reader after a duration corresponding to N times a specific reference time length T_ref. For example, a duration of N times the specific reference time length T_ref may be a waiting time for Msg4 transmission or an offset time. The device may transmit Msg3 including N to the reader. The reader may receive Msg3 including N from the device. In other words, the device may transmit a value of N to the reader by including the value of N in a message or control information of DR PDRCH for Msg3 in consideration of an energy harvesting state. The reader may receive the message or control information of the DR PDRCH for Msg3 including the value of N from the device.

N may be 1. If information bits for N are configured as a single bit, the reader may interpret the one-bit information for N as information on whether to apply an offset. T_ref may be predefined in technical specifications. The reader may deliver T_ref to the device through an RRC higher layer message. The device may receive the RRC higher layer message including T_ref from the reader.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first communication node, comprising:
transmitting, to a second communication node, a paging message including message 1 (Msg1) occasion configuration information;
transmitting, to the second communication node, a trigger message for causing the second communication node to determine a transmission time of Msg1; and
receiving, from the second communication node, Msg1 including first sequence randomly selected from among designated arbitrary sequence.

2. The method of claim 1, wherein the paging message further includes information for initiating an inventory procedure.

3. The method of claim 1, wherein the trigger message further includes at least one of: information on a current transmission round, information on a time interval until a next trigger message, or information on a number of remaining trigger messages.

4. The method of claim 1, wherein the Msg1 occasion configuration information includes at least one of: information on a time-domain transmission resource, or information on a frequency-domain transmission resource.

5. The method of claim 1, wherein the Msg1 occasion configuration information includes information on slots corresponding to a slotted Aloha transmission procedure, and the information on slots corresponding to the slotted Aloha transmission procedure includes at least one of: information on a total number of slots, information on a start time of a first slot, information on a time length of a slot, information on a start time at which the slots are configured, or information on an end time at which the slots are configured.

6. The method of claim 4, wherein the information on the time-domain transmission resource includes at least one of: information on a number of transmission resources, information on a start time of the transmission resource, information on a first time offset between the transmission resource and an adjacent transmission resource, information on a second time offset indicating a start time of the transmission resource, information on a minimum transmission time of the transmission resource, or information on a maximum transmission time of the transmission resource.

7. The method of claim 1, further comprising:
transmitting, to the second communication node, Msg2 including an identifier (ID) assigned to the second communication node for confirmation of the first sequence and for recognition between the first communication node and identifier of the second communication node or message 3 (Msg3) occasion configuration information; and
receiving Msg3 from the second communication node.

8. The method of claim 7, wherein the Msg1 includes information on an energy state change of the second communication node, and the transmitting of the Msg2 comprises:
adjusting a transmission time of Msg2 by taking into account the energy state change; and
transmitting Msg2 to the second communication node at the adjusted transmission time.

9. A method of a second communication node, comprising:
receiving, from a first communication node, a paging message including message 1 (Msg1) occasion configuration information;
receiving, from the first communication node, a trigger message; and
transmitting, to the first communication node, Msg1 including first sequence randomly selected from among designated sequences, at a transmission time determined by the trigger message in response to the paging message.

10. The method of claim 9, the Msg1 occasion configuration information includes at least one of: information on a time-domain transmission resource or information on a frequency-domain transmission resource.

11. The method of claim 10, wherein the information on the time-domain transmission resource includes at least one of: information on a frequency of a carrier wave, information on a small frequency shift value, information on slots corresponding to a slotted Aloha transmission procedure, information on a time-domain transmission resource, or information on a frequency-domain transmission resource.

12. The method of claim 9, further comprising:
receiving, from the first communication node, Msg2 including an identifier (ID) assigned to the second communication node for confirmation of the first sequence and for recognition between the first communication node and the second communication node or message 3 (Msg3) occasion configuration information; and
transmitting, to the first communication node, Msg3 in response to the Msg2.

13. The method of claim 12, wherein the Msg1 includes information on an energy state change of the second communication node, and the receiving of the Msg2 comprises:
configuring a monitoring time of the Msg2 according to the energy state change;
monitoring the Msg2 at the configured monitoring time; and
receiving the Msg2 at the configured monitoring time.

14. The method of claim 12, further comprising:
wherein transmitting Msg3 to the first communication node comprises:
determining transmission resource and a transmission time of Msg3 based on Msg3 resource configuration information included in Msg2; and
transmitting Msg3 at the transmission time on the determined transmission resource.

15. A second communication node comprising at least one processor, wherein the at least one processor causes the second communication node to perform:
receiving, from a first communication node, a paging message including message 1 (Msg1) occasion configuration information;
receiving, from the first communication node, a trigger message; and
transmitting, to the first communication node, Msg1 including first sequence randomly selected from among designated sequences, at a transmission time determined by the trigger message in response to the paging message.

16. The second communication node of claim 15, the Msg1 occasion configuration information includes at least one of: information on a time-domain transmission resource or information on a frequency domain transmission resource.

17. The second communication node of claim 16, wherein the information on the time-domain transmission resource includes at least one of: information on a frequency of a carrier wave, information on a small frequency shift value, information on slots corresponding to a slotted Aloha transmission procedure, information on a time-domain transmission resource, or information on a frequency-domain transmission resource.

18. The second communication node of claim 15, wherein the at least one processor further causes the second communication node to perform:
receiving, from the first communication node, Msg2 including an identifier (ID) assigned to the second communication node for confirmation of the first sequence and for recognition between the first communication node and the second communication node or message 3 (Msg3) occasion configuration information; and
transmitting, to the first communication node, Msg3 in response to the Msg2.

19. The second communication node of claim 18, wherein the Msg1 includes information on an energy state change of the second communication node, and in the receiving of the Msg2, the at least one processor causes the second communication node to perform:
configuring a monitoring time of the Msg2 according to the energy state change;
monitoring the Msg2 at the configured monitoring time; and
receiving the Msg2 at the configured monitoring time.

20. The second communication node of claim 18, wherein in transmitting Msg3 to the first communication node, the at least one processor further causes the second communication node to perform:
determining transmission resource and a transmission time of Msg3 based on Msg3 resource configuration information included in Msg2; and
transmitting Msg3 at the transmission time on the determined transmission resource.
